(19) United States
(12) Patent Application Publication
(10) Pub. No.: US 2018/0128461 A1
(43) Pub. Date: May 10, 2018

(54) MULTI-BODIED FLASHLIGHT

(71) Applicant: Hy Le, Las Vegas, NV (US)

(72) Inventor: Hy Le, Las Vegas, NV (US)

(21) Appl. No.: 15/807,345

(22) Filed: Nov. 8, 2017

Related U.S. Application Data
(60) Provisional application No. 62/419,343, filed on Nov. 8, 2016.

(51) Int. Cl. F21V 21/14; F21V 23/04; F21L 4/02; F21L 4/08; F21V 7/06

(52) U.S. Cl. CPC F21V 21/14; F21V 23/0414; F21Y 2115/10; F21L 4/08; F21V 7/06; F21L 4/02

(57) ABSTRACT

Apparatuses and methods are disclosed for a multi-bodied flashlight. One apparatus includes a primary flashlight including a primary casing, a primary lighting element, and a primary power circuit. The apparatus includes a secondary flashlight including a secondary casing and a secondary lighting element. The apparatus includes a junction member including a first end coupled to the primary casing and a second end coupled to the secondary casing.

### FIELD

The subject matter disclosed herein relates to flashlights and more particularly relates to a multi-bodied flashlight.

### BACKGROUND

### Description of the Related Art

A flashlight may be used for illuminating a desired area. Unfortunately, a flashlight may be limited in its ability to illuminate one or more desired areas.

### BRIEF SUMMARY

A multi-bodied flashlight apparatus is disclosed. A method for manufacturing the apparatus is also disclosed. In one embodiment, the apparatus includes a primary flashlight including a primary casing, a primary lighting element, and a primary power circuit. The apparatus, in various embodiments, includes a secondary flashlight including a secondary casing and a secondary lighting element. The apparatus, in some embodiments, includes a junction member including a first end coupled to the primary casing and a second end coupled to the secondary casing.

In some embodiments, the junction member includes a pivot that enables the first end and the second end of the junction to move independently. In one embodiment, the primary flashlight includes a cavity, and the secondary flashlight and junction member are movable between a first position inside the cavity and a second position outside the cavity.

In another embodiment, the primary power circuit includes a primary power source and an alternative primary power source. In some embodiments, the secondary flashlight includes a secondary power circuit. In certain embodiments, the secondary power circuit includes a secondary power source and an alternative secondary power source. In various embodiments, the primary power circuit includes a lighting mode module. In some embodiments, the secondary power circuit includes a lighting mode module.

A multi-bodied flashlight apparatus, in one embodiment, includes a primary flashlight and a secondary flashlight rotatably coupled to the primary flashlight.

In some embodiments, the secondary flashlight is removably coupled to the primary flashlight. In one embodiment, the primary flashlight includes an opening configured to store the second flashlight therein.

In another embodiment, the primary flashlight and the secondary flashlight are substantially the same size. In some embodiments, the primary flashlight and the secondary flashlight are a different size from one another. In certain embodiments, the primary flashlight is larger than the secondary flashlight. In various embodiments, the primary flashlight and the secondary flashlight are controlled together using a single switch. In some embodiments, the primary flashlight is controlled using a first switch and the second flashlight is controlled using a second switch.

A method for manufacturing a multi-bodied flashlight apparatus, in one embodiment, includes providing a primary flashlight. In some embodiments, the method includes providing a secondary flashlight. In various embodiments, the method includes rotatably coupling the primary flashlight to the secondary flashlight.

In some embodiments, rotatably coupling the primary flashlight to the secondary flashlight includes attaching a junction member to the primary flashlight and to the secondary flashlight. In various embodiments, rotatably coupling the primary flashlight to the secondary flashlight includes attaching a pivot between the primary flashlight and to the secondary flashlight. In one embodiment, the pivot enables rotation of the secondary flashlight relative to the primary flashlight in multiple directions.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a left side view illustrating one embodiment of a multi-bodied flashlight in accordance with one embodiment of the present disclosure;

FIG. 2 is a top side view further illustrating the multi-bodied flashlight of FIG. 1 in accordance with one embodiment of the present disclosure;

FIG. 3 is a side view further illustrating the multi-bodied flashlight of FIG. 1 in accordance with one embodiment of the present disclosure;

FIG. 4 is a detail view illustrating a secondary flashlight that retracts within a primary casing in accordance with one embodiment of the present disclosure;

FIG. 5 is a front side view illustrating the multi-bodied flashlight in accordance with one embodiment of the present disclosure;

FIG. 6 is a schematic block diagram illustrating a power circuit of a multi-bodied flashlight in accordance with one embodiment of the present disclosure;

FIG. 7 is a schematic block diagram illustrating a power circuit of one embodiment of a multi-bodied flashlight including an alternative power source in accordance with one embodiment of the present disclosure;

FIG. 8 is a schematic block diagram illustrating a power circuit of one embodiment of a multi-bodied flashlight including lighting mode modules in accordance with one embodiment of the present disclosure; and

FIG. 9 is a schematic block diagram illustrating discrete power circuits for primary and secondary flashlights of one embodiment of a multi-bodied flashlight in accordance with one embodiment of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

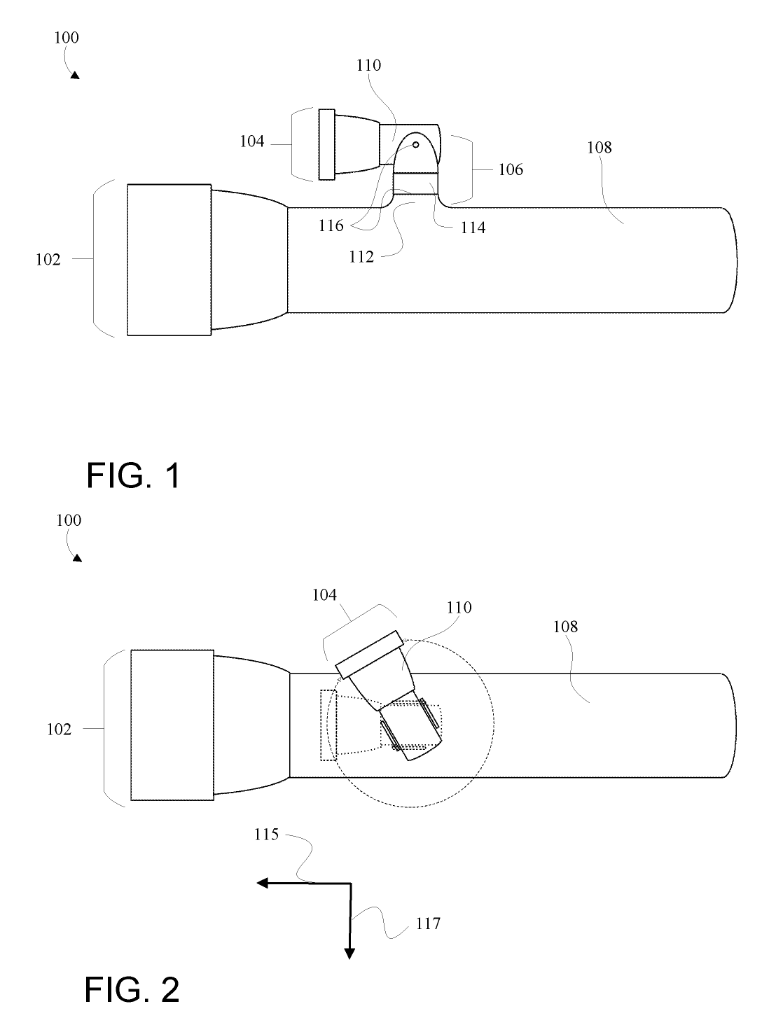

FIG. 1 is a left side view illustrating one embodiment of a multi-bodied flashlight in accordance with one embodiment of the present disclosure. The apparatus 100 includes a primary flashlight 102, at least one secondary flashlight 104, and a junction member 106. The primary flashlight 102 includes a primary casing 108. The secondary flashlight 104 includes a secondary casing 110.

Some embodiments of the disclosure may only include one secondary flashlight 104, whereas others may include more than one secondary flashlight 104. References to the secondary flashlight 104 in the singular, as well as references in the singular to the secondary casing 110 and other structures or components that the secondary flashlight 104 includes in the various embodiments of the disclosure, also refer to the plural, to account for embodiments including multiple secondary flashlights 104. In some embodiments, the primary flashlight 102 may be the same size (e.g., approximately the same size, substantially the same size) as the secondary flashlight 104; while, in other embodiments, the primary flashlight 102 may be a different size than the secondary flashlight 104. In certain embodiments, the secondary flashlight 104 is smaller than the primary flashlight 102.

The junction member 106 includes a first end 112, a second end 114 and a pivot 116. The first end 112 is coupled to the primary casing 108, and the second end 114 is coupled to the secondary casing 110.

In some embodiments, the first end 112 of the junction member 106 is molded directly into the primary casing 108. Further embodiments contemplate molding the first end 112 of the junction member 106 directly into the primary casing 108 and the second end 114 of the junction member 106 directly into the secondary casing 110. However, most embodiments employing this configuration still include the pivot 116 as part of the junction member 106, to allow movement of the secondary flashlight 104 in relation to the primary flashlight 102.

Different embodiments will locate the pivot 116 at different points along the junction member 106. Some embodiments locate the pivot 116 at the midpoint of the junction member 106, while others locate the pivot 116 at the point where the first end 112 of the junction member 106 meets the primary casing 108 or at the point where the second end 114 of the junction member meets the secondary casing 110, or there may be multiple pivots 116 (e.g., pivots 116 at one or more locations described herein). The pivot 116 may be placed at any point along the junction member 106 and retain the essential spirit and essence of the present disclosure.

An alternative method of coupling is done by means of a bracket sized to receive the primary flashlight 102 or the secondary flashlight 104. Some embodiments include only one bracket, whereas other embodiments will include multiple brackets, receiving both the primary flashlight 102 and the secondary flashlight 104.

The bracket is secured against the primary casing 108 or the secondary casing 110 by means of a fastener member which increases the force with which the bracket is held against the primary casing 108 or the secondary casing 110. In some embodiments the bracket may substantially surround the primary casing 108 or secondary casing 110, and the fastener member may draw two portions of the bracket closer together to increase the retention force against the primary casing 108 or the secondary casing 110. In other embodiments, the fastener member may simply couple the bracket to the primary casing 108 or the secondary casing 110 by engaging directly into the primary casing 108 or secondary casing 110.

Regardless of the specific method of coupling, the primary flashlight 102 and the secondary flashlight 104 may be removably coupled to the junction member 106, or it may be permanently coupled to the junction member 106. Different embodiments of the disclosure include either permanent or removable coupling.

FIG. 2 is a top side view further illustrating the multi-bodied flashlight of FIG. 1 in accordance with one embodiment of the present disclosure. In some embodiments, the pivot 116 permits 360-degree movement of the secondary flashlight 104 (or a smaller degree of movement, such as 90-degree, 180-degree, 270-degree, etc.) in a first plane oriented parallel to a first axis of the primary flashlight 102 that extends in a first direction 115 perpendicular to a second direction 117. In some exemplary embodiments, the pivot 116 includes a standard swivel joint, well known in the art, to achieve this functionality.

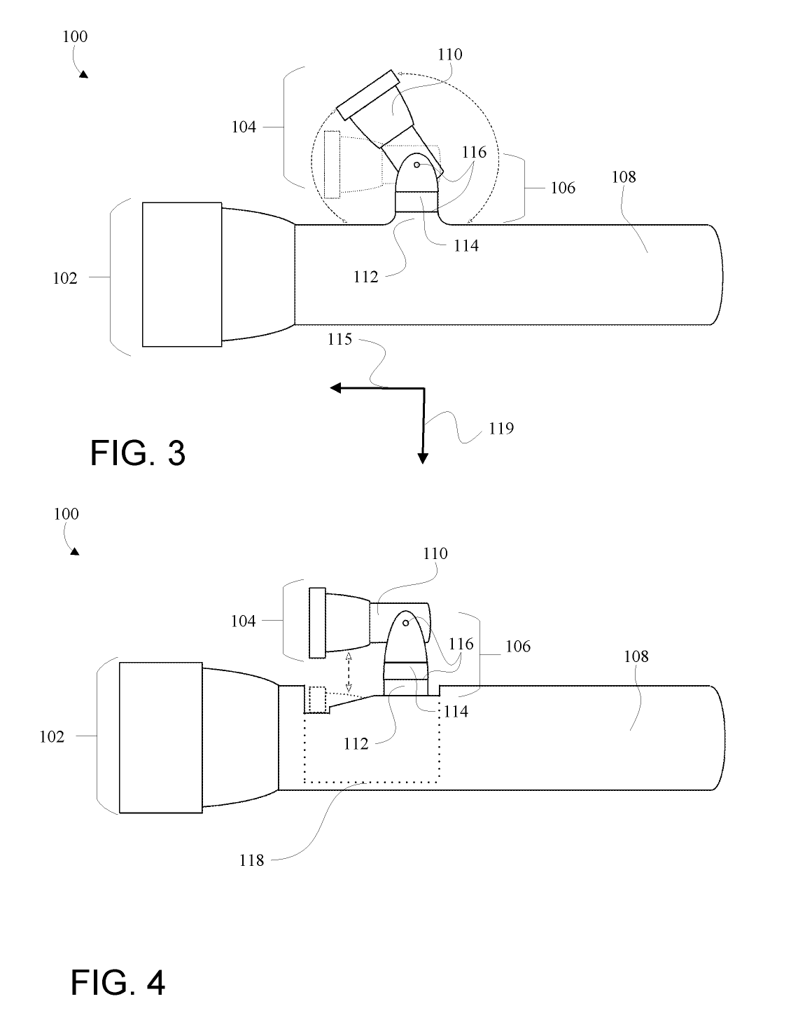

FIG. 3 is a side view further illustrating the multi-bodied flashlight of FIG. 1 in accordance with one embodiment of the present disclosure. Some embodiments may include a pivot 116 that permits movement of the secondary flashlight 104 in a second plane oriented perpendicular to the first axis of the primary flashlight 102. The second plane extends in a third direction 119 perpendicular to the first direction 115. In some embodiments, the pivot 116 additionally includes a standard hinge-type joint, well known in the art, to achieve this functionality.

Some embodiments may also include two separate pivots 116, one configured to operate in the first plane oriented parallel to a first axis of the primary flashlight 102, and the other configured to operate in the second plane oriented perpendicular to the first plane. In such a configuration, both pivots 116 may be placed next to one another at any location along the junction member 106. Alternatively, both pivots 116 may be placed at different locations along the junction member 106, including the points at which the junction member 106 is coupled to the primary casing 108 and the secondary casing 110.

By allowing the secondary flashlight 104 to move relative to the primary flashlight 102, the area that is lit up by the flashlights can be adjusted more precisely, and can allow for a wider angle of illumination as needed by the user. Furthermore, in some embodiments the primary flashlight 102 and the secondary flashlight 104 have different performance characteristics that may be better used if they can be pointed in different directions simultaneously.

In some embodiments, movement of the secondary flashlight 104 by means of the pivot 116 is completely free, with no preset positions or locking mechanism. In other embodiments, the pivot 116 or pivots 116 may additionally include detents at points throughout the range of movement, at which points movement of the secondary flashlight 104 is releasably detained, and between which points movement is free. Some embodiments may include detents at regular intervals through the range of movement, such as every 45 degrees or every 90 degrees, or may include detents at non-regular intervals. Further embodiments may include a locking system such that the user may allow free movement throughout range of movement, and releasably lock the secondary flashlight 104 at any position throughout the 360 degrees of movement. Such detents and locking systems may be applied to movements in any direction, including movements in the first plane oriented parallel to the first axis of the primary flashlight 102 and the second plane oriented perpendicular to the first axis of the primary flashlight 102.

Yet further embodiments may include a single pivot 116 that permits movement of the secondary flashlight 104 in both the first plane and the second plane. One example of such an embodiment would include the first plane parallel to a longitudinal axis of a substantially cylindrical primary flashlight 102 held in a substantially horizontal position, and the second plane perpendicular to the first plane; wherein the motion in the first plane is substantially horizontal, and the motion in the second plane is substantially vertical.

In some embodiments including a pivot 116 capable of movement in at least two perpendicular planes as disclosed herein, the pivot 116 includes a ball and socket type joint. In some of these embodiments, the pivot additionally includes a locking member that exerts force upon the ball portion of the ball and socket joint, thereby locking in place the end of the junction member 106 attached to the ball portion. Other embodiments may include a locking member that exerts force upon the socket portion of the ball and socket joint to resist movement of the ball portion of the ball and socket joint. Yet further embodiments contemplate alternative locking mechanisms to be used with ball and socket joints, as well as with swivel, hinge, and other types of joints.

The embodiments described herein are not limited to the specific types of pivots 116 described herein. In other embodiments, the pivot 116 or pivots 116 may include an alternative type of joint that allows for the necessary movement as described

Also, the pivot 116 is not limited to the junction member 106. In some embodiments, the primary flashlight 102 may also include a pivot 116 or multiple pivots 116 in the primary casing 108, such that the end of the primary casing 108 from which light is produced may be moved in the first plane oriented parallel to the first axis of the primary flashlight 102 and/or the second plane oriented perpendicular to the first axis of the primary flashlight 102, similar to the movements described in relation to the pivot 116 in the secondary flashlight 104. Some embodiments include at least one pivot 116 for both the primary flashlight 102 and the secondary flashlight 104.

FIG. 4 is a detail view illustrating a secondary flashlight 104 that retracts within the primary casing 108 in accordance with one embodiment of the present disclosure. In some embodiments, the secondary flashlight 104 and junction member 106 can be retracted to lie within a cavity 118 in the primary casing 108, thus removing any ergonomic or other variety of disturbance that the secondary flashlight 104 might cause while not in use.

In some embodiments, the secondary flashlight 104 and junction member 106 may be retracted and extended manually by the user. In such a case, when the secondary flashlight 104 is completely outside of the cavity 118 (the “extended position”), the user simply pushes the secondary flashlight 104 into the cavity 118 (the “retracted position”). To put the secondary flashlight 104 into the extended position, the user simply grasps the secondary flashlight 104 and moves it into the extended position.

In such an arrangement, the junction member 106 may be coupled to the primary casing 108 by a variety of methods. One method includes a friction fit between the junction member 106 and the primary casing 108 that allows movement of the junction member 106 and secondary flashlight 104, while retaining the junction member 106 and secondary flashlight 104 in the desired position once released.

Further embodiments may include a manual lock that allows for free movement until it is actuated by the user, after which the manual lock holds the junction member 106 and secondary flashlight 104 in the desired position.

Some embodiments including a retractable secondary flashlight 104 also include detents along the grooves corresponding to at least the extended position and the retracted position such that the junction member 106 is releasably detained at the selected positions, to additionally secure the junction member 106 in the extended position or the retracted position, as well as any intermediate positions as desired.

In some embodiments, the junction member 106 includes a spring force member to provide a spring force that pushes the junction member 106 and secondary flashlight 104 in a direction pointed out of the cavity 118. Such embodiments also include a standard “push-push” mechanism, well known in the art, that can retain the secondary flashlight 104 in both the extended position and the retracted position.

When the secondary flashlight 104 is in the extended position, the user simply pushes the secondary flashlight 104 into the cavity 118. After the secondary flashlight 104 reaches the retracted position and the user releases the secondary flashlight 104, the push-push mechanism catches against the junction member 106, and retains the secondary flashlight 104 within the primary casing 108. When needed, the user simply pushes on the secondary flashlight 104 in a direction opposite the direction of the force of the spring force member to disengage the push-push mechanism, and the spring force member pushes the junction member 106 and the secondary flashlight 104 out of the cavity 118 until the secondary flashlight reaches the extended position, after which the push-push mechanism catches against the junction member 106, thereby retaining the secondary flashlight 104 in the extended position.

Yet other embodiments include a spring force member, which exerts a force on the junction member 106, pushing the junction member 106 out of the cavity. However, when the secondary flashlight 104 is in the retracted position, a catch holds the junction member 106 in place. When actuated by the user, a release member moves the catch off of the junction member 106, and the allows the force of the spring force member to move the junction member 106 (and, subsequently, the secondary flashlight 104) out of the cavity 118 until a retention member contacts the primary casing 108 and retains the secondary flashlight 104 at the extended position. To return the secondary flashlight 104 to the retracted position, the user simply exerts a force in a direction opposite that of the spring force member until the catch retains the junction member, thereby retaining the secondary flashlight 104 in the retracted position.

Some embodiments that include a retractable secondary flashlight 104 also include a door that covers the cavity 118 when the secondary flashlight 104 is in the retracted position, thereby protecting the secondary flashlight 104 from external conditions when not in use.

Other embodiments of the disclosure contemplate other mechanisms for retraction and extension of the secondary flashlight 104 in and out of the cavity 118, and such variations fall within the essential spirit and vision of the present disclosure.

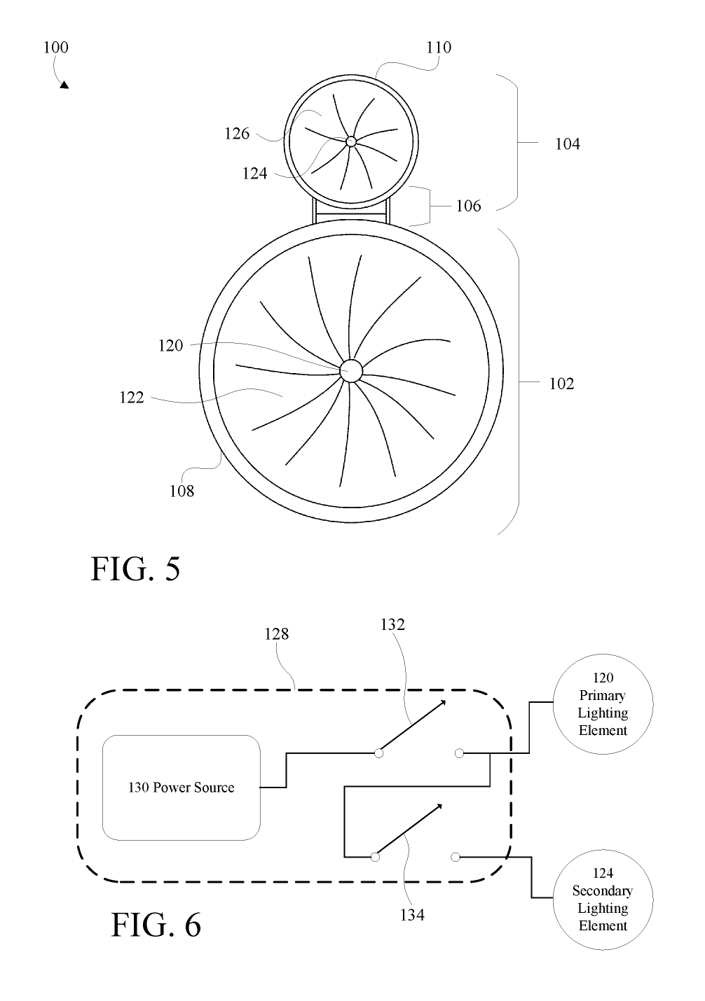

FIG. 5 is a front side view illustrating the multi-bodied flashlight in accordance with one embodiment of the present disclosure. The primary flashlight 102 additionally includes a primary lighting element 120 and a primary reflector 122. The secondary flashlight 104 includes a secondary lighting element 124 and a secondary reflector 126.

Different embodiments of the disclosure contemplate different types of lighting elements used for the primary lighting element 120 and the secondary lighting element 124. In some embodiments, the primary lighting element and secondary lighting element 124 include one or multiple light-emitting diodes (“LED's) of identical or differing configurations and types.

Furthermore, different embodiments of the disclosure include different sub-types of lighting elements. For example, LED's are available in a variety of different sub-types, and may emit light at different wavelengths across the visible spectrum and beyond. Visible red light, for example, is useful to illuminate objects at night while still maintaining one's “night vision,” the increased sensitivity gained when the eyes have adjusted to low light situations. In other applications, an ultra-violet emission may be desirable. Yet other applications may call for other types of emissions.

Other types of LED's combine two, three or more different types of LED's with different characteristics into one package. Different embodiments will include different types of LED's and subtypes of LED's, and fall within the scope of the subject matter disclosed.

Additionally, different types or sub-types of lighting elements may be used in the primary flashlight 102 and the secondary flashlight 104. For example, the primary flashlight 102 may include a standard white LED for general purpose use, whereas the secondary flashlight 104 may include an LED configured to emit red light to maintain increased visual sensitivity in low-light situations. Other embodiments contemplate the simultaneous use of different types or sub-types of lighting elements in the primary flashlight 102 and the secondary flashlight 104.

The “throw” and “flood” characteristics of the light produced is an important consideration in flashlight design. A “flood” type light attempts to distribute light evenly in all directions around the flashlight to light the immediate area, whereas a “throw” light attempts to direct the light parallel to the longitudinal axis of the flashlight, in order to illuminate far-away objects. A common dilemma of flashlight users is deciding between which type of flashlight to carry, knowing that different situations will require different amounts of flood or throw. The current subject matter addresses this problem by providing different configurations for the primary flashlight 102 and the secondary flashlight 104, so that a user may have a choice as to the “throw” characteristics is appropriate for the circumstances. In one embodiment, the primary flashlight 102 may use a flood type light and the secondary flashlight 104 may use a throw type light. In another embodiment, the primary flashlight 102 may use a throw type light and the secondary flashlight 104 may use a flood type light. Other embodiments, may have any other type of combination of throw and flood type lights which may be selected by a user.

Some embodiments of the disclosure include a primary reflector 122 and a secondary reflector 126 that are similar, offering similar performance in terms of throw and flood of the primary flashlight 102 and the secondary flashlight 104. However, in other embodiments, one of either the primary reflector 122 or the secondary reflector 126 is configured for better throw of the flashlight beam, and the other is configured for better flood performance. These throw and flood characteristics are achieved by various reflector designs well known in the art, such as parabolic reflectors. Other embodiments include different types of reflectors well known in the art to achieve different lighting performance characteristics.

FIG. 6 depicts a schematic block diagram illustrating the power circuit 128 of a multi-bodied flashlight in accordance with one embodiment of the present disclosure. As described above, the disclosure includes a primary flashlight 102 and a secondary flashlight 104. The primary flashlight 102 includes a power circuit 128. In some embodiments, the power circuit 128 in the primary flashlight 102 powers both the primary lighting element 120 and the secondary lighting element 124. In such embodiments, the connection to the secondary lighting element 124 may be made by an external “umbilical” connection, or the connection may be made from the primary casing 108 through the interior of the junction member 106 and into the secondary casing 110. In a case where the secondary flashlight 104 is removable, the umbilical connection additionally includes at least one detachable connector, to allow disconnection and reconnection of the secondary flashlight 104.

In other embodiments, the secondary flashlight 104 includes its own, independent power circuit 128. In those embodiments in which the secondary flashlight 104 includes a power circuit 128, the power circuit 128 may be identical to the one used in the primary flashlight 102, or it may include a variation of the power circuit 128. The power circuit 128 is described herein, understanding that both the primary flashlight 102 and the secondary flashlight 104 can, depending on the specific embodiment, include a version of the power circuit 128, and the power circuits 128 used may, but need not, be identical.

The power circuit 128 provides electrical power to the flashlight. The power circuit 128 includes a power source 130 and a power switch 132. In embodiments with such a configuration, the power switch 132 completes the circuit, sending current from the power source 130 through the primary lighting element 120 and back to the power source 130, turning on the flashlight. Once flashlight is activated, the power switch 132 is also capable of interrupting the circuit, to turn off the flashlight.

In embodiments in which the secondary flashlight 104 does not include a power circuit 128, the power switch 132 in the power circuit 128 of the primary flashlight 104 controls the flow of current to both the primary lighting element 120 and the secondary lighting element 124 simultaneously, thus allowing the user to provide power to both the primary lighting element 120 and the secondary lighting element 124 with one switch.

Some of the embodiments that include the retractable secondary flashlight 104 described herein additionally include a cutoff switch 134 that interrupts the power going to the secondary lighting element 124 when the secondary flashlight 104 is in the retracted position, regardless of whether the secondary flashlight 104 includes a power circuit 128 in that specific embodiment.

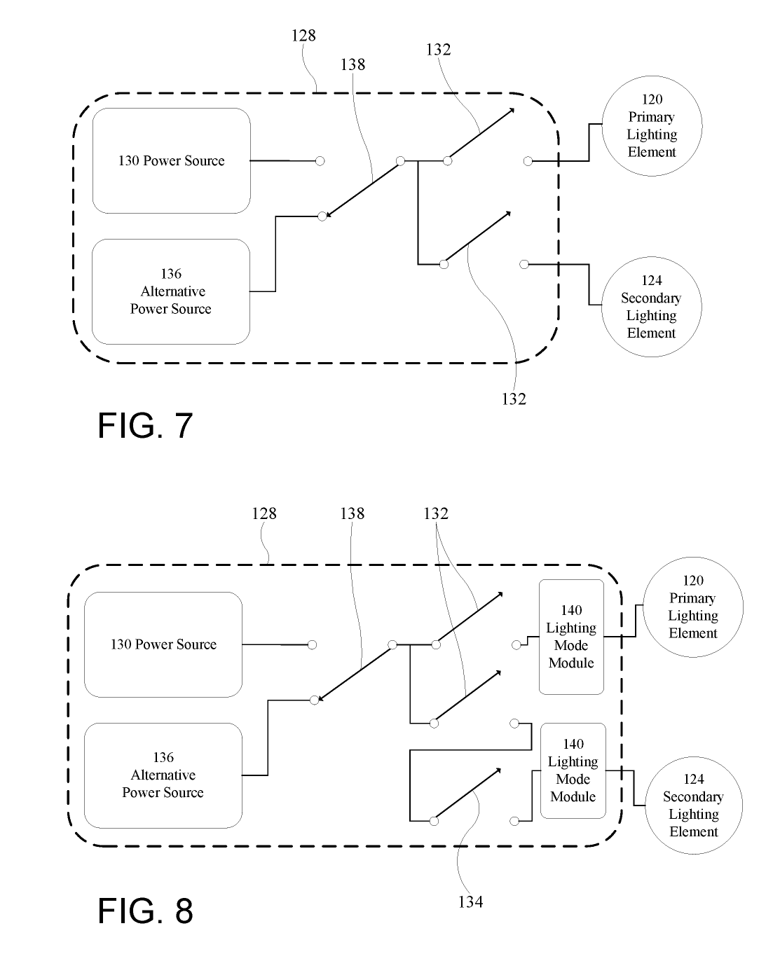

FIG. 7 is a schematic block diagram illustrating the power circuit 128 of one embodiment of a multi-bodied flashlight including an alternative power source 136 in accordance with one embodiment of the present disclosure. In some embodiments, the power circuit 128 additionally includes at least one alternative power source 136. In such a configuration, the user may choose which source is desired, the power source 130 or the alternative power source 136, through the power switch 132. In some embodiments with this feature, the power switch 132 includes an on-off-on DPDT type switch, well known in the art, to switch between the power source 130, the alternative power source 136, and no connection. Other embodiments may include a switch with sufficient connections to accommodate more than one alternative power source 136, as well as a position for no connection for an “off” position. One example would include a DP4T switch to accommodate the power source 130, two alternative power sources 136, and an “off” position. With such a design, accidental simultaneous connection of both the power source 130 and alternative power source 136 is avoided.

Alternative embodiments may include a separate power source selector switch 138 used to select between the power source 130 and the alternative power source 136, wherein the power switch 132 only performs the function of completing the circuit between the power source 130 or alternative power source 136 and the lighting element. One example includes a DPDT switch as the power source selector switch 138 to select between the power source 130, and the alternative power source 136, and a SPST switch as the power switch 132. Embodiments including more than one alternative power source 136 would include a switch with connections sufficient to connect all of the alternative power sources 136 as the power source selector switch 138. For example, an embodiment including a power source 130 and two alternative power sources 136 could employ a DP3T switch as the power source selector switch 138, and an embodiment including a power source 130 and three alternative power sources 136 could employ a DP4T switch as the power source selector switch 138.

Other embodiments of the disclosure may include a combination power switch to place the power source 130 and the alternative power source 136 in a serial or a parallel configuration, depending on the individual embodiment, such that the power source 130 and the alternative power source 136 may be used simultaneously to power the primary lighting element 120 or the secondary lighting element 124. Such embodiments include a power source 130 and alternative power source 136 that are compatible for this feature. Some embodiments place the power source 130 and alternative power source 136 in parallel only, other embodiments place the power source 130 and alternative power source 136 in series, and yet others have the option for either a series or a parallel arrangement. Further embodiments contemplate different combinations of series and parallel arrangements, especially when the embodiment includes multiple alternative power sources 136.

Different embodiments of the disclosure incorporate different configurations of the power circuit 128. In some embodiments, the power circuit 128 for the primary flashlight 102 may include an alternative power source 136, as described above, yet a power circuit 128 for the secondary flashlight 104 may only include one source. Other embodiments may include alternative power sources 136 for both the primary flashlight 102 and the secondary flashlight 104. Further embodiments may only include alternative power sources 136 in the power circuit 128 for the secondary flashlight 104, and not for the primary flashlight 102.

Embodiments including an alternative power source 136 can be configured in a number of ways. Some embodiments may include a power source 130 and an alternative power source 136 that are identical. One example would be a power source and an alternative power source that both include a AA type battery. Other embodiments may include a power source 130 and an alternative power source 136 that offer different characteristics, such as electrical performance and form factor.

The power source 130 and alternative power source 136 may include batteries, alternators, dynamos, solar cells, connections to external power sources or other sources employing various means of producing electricity, be they chemical, mechanical or otherwise. Even if the sources are all of the same type (e.g. batteries), different variations of power sources 130 and alternative power sources 136 within the same type offer different features or performance characteristics that may be desirable in different circumstances.

For example, some embodiments of the disclosure may include a AA type battery, operating at 1.5 volts. An alternative power source 136 including a CR123 type battery, operating at 3 volts, may be useful as an alternative. Differences in performance characteristics of alternative power sources 136, such as operating voltage, provide different operating characteristics for the flashlight, such as brightness output or runtime, that may be desirable in certain situations.

Physical characteristics of different sources provide another consideration for including an alternative power source 136. To use a similar example as before, a CR123 type battery is shorter along its longitudinal axis than is a AA type battery, and therefore lends itself better to use in certain embodiments with less available space for power sources 130 or alternative power sources 136.

However, despite the advantages that CR123 type batteries offer, in other situations users may prefer flashlights using AA type batteries, as they are more common and more cost effective than CR123 type batteries. Even in some of the embodiments disclosed herein, a smaller form factor may prove useful to provide more flexibility in arrangement of internal components, or to fit multiple batteries in a space where only one battery of another type would fit. Traditionally, users had to choose one or the other for their flashlights, or carry multiple flashlights to take advantage of different characteristics of different sources. The embodiments described within including an alternative power source 136 can combine the advantages of multiple sources into one unit, thus reducing such problems.

Some embodiments include a recharging circuit in the power circuit 128 to recharge appropriate rechargeable power sources 130 and alternative power sources 136 used in the primary flashlight 102 and the secondary flashlight 104. Such circuits are well known in the art, but their use in the embodiments herein offer specific advantages that traditional designs cannot utilize. For example, in embodiments including a power source 130 and an alternative power source 136, the recharging circuit may be configured to use the power from the alternative power source 136 to recharge the power source 130. This could be done where the power source 130 includes a rechargeable battery, and the alternative power source includes a non-rechargeable battery. Other embodiments could include rechargeable batteries for both the power source 130 and the alternative power source 136. Yet further embodiments could include a solar cell and circuit as the alternative power source 136 and a rechargeable battery as the power source 130.

Furthermore, the embodiments are not limited to using the alternative power source 136 to recharge the power source 130. Other embodiments include a recharging circuit capable of using energy from the power source 130 to recharge the alternative power source 136.

Yet other embodiments may also include a recharging circuit configured to charge external devices using power from the power source 130 and/or the alternative power source 136, such as a smart phone or a global positioning system unit through an external charging port. In some embodiments, such an external charging port could be a USB type port, or it could be another type of connector common to the art. Persons competent in the art will recognize the obvious applications and variations of various embodiments contemplated by the current subject matter.

FIG. 8 is a schematic block diagram illustrating the power circuit of one embodiment of a multi-bodied flashlight including lighting mode modules 140 in accordance with one embodiment of the present disclosure. In some embodiments of the current subject matter, the power circuit 128 additionally includes a lighting mode module 140, capable of controlling the primary lighting element 120 to implement different lighting modes as required by the specific embodiment. Different embodiments of the disclosure contemplate different lighting modes, such as strobe modes or beacon modes, as well as modes providing varying levels of intensity of emitted light, among others. These different modes are well known in the art, and need no detailing here. However, the use of various lighting modes in the current subject matter provides specific advantages not available in other designs.

Additional embodiments include a lighting mode module 140 corresponding to the primary lighting element 120 and primary flashlight 102, and another lighting mode module 140 that corresponds to the secondary lighting element 124 and secondary flashlight 104. Such embodiments include options to use the same lighting mode for both the primary lighting element 120 and the secondary lighting element 124, or to use different modes. For example, the primary flashlight 102 may be configured to operate in a high-intensity illumination mode, whereas the secondary flashlight 104 may be configured to operate in a low-intensity illumination mode to use less amounts of energy. In other embodiments, the secondary flashlight 104 operates in a strobe mode to act as a distraction or to call another's attention. Different embodiments will include different combinations of lighting modes appropriate for different applications and circumstances. No specific lighting mode is limited to use in either the primary flashlight 102 or the secondary flashlight 104, nor are the primary flashlight 102 and secondary flashlight 104 limited to any one lighting mode.

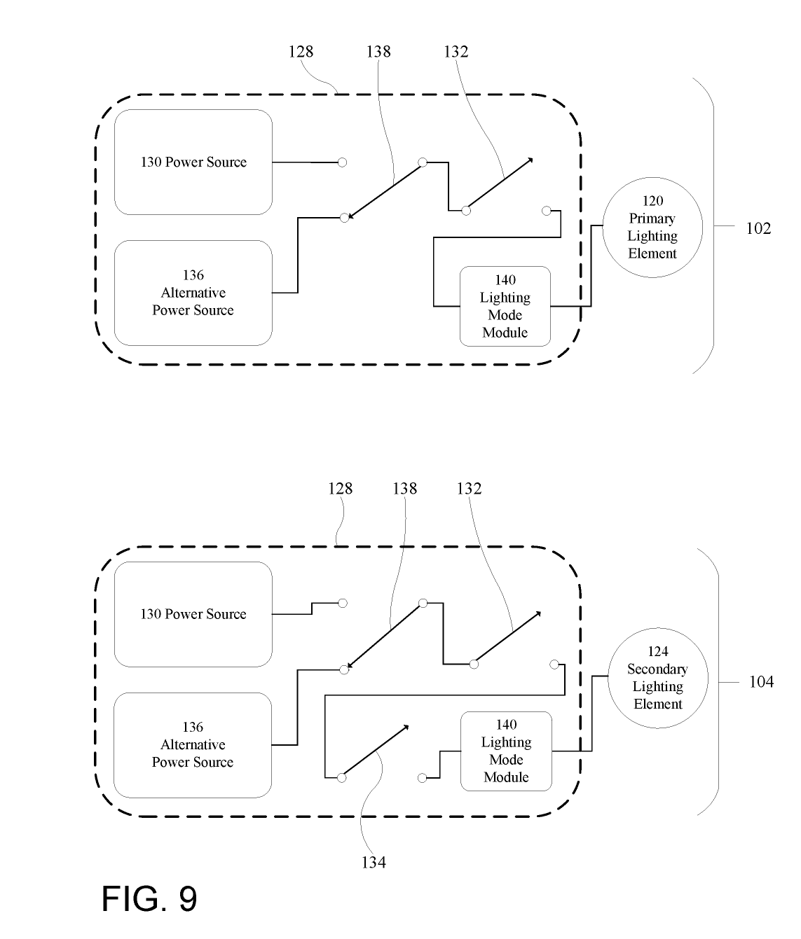

FIG. 9 is a schematic block diagram illustrating the discrete power circuits 128 for the primary and secondary flashlights of one embodiment of a multi-bodied flashlight in accordance with one embodiment of the present disclosure. Some embodiments include discrete power circuits 128 for both the primary flashlight 102 and the secondary flashlight 104. In these embodiments, the power circuit for the primary flashlight 102 is completely separated from the power circuit 128 for the secondary flashlight 104, and operate independently. Different power circuits 128 of various embodiments include various combinations of the power source 130, alternative power source 136, power switch 132, lighting mode module 140, power source selector switch 138 and lighting mode module 140.

In different embodiments including independent power circuits 128 for the primary flashlight 102 and the secondary flashlight 104, the physical locations of different components vary. For example, in some embodiments, all the components of the power circuit 128 corresponding to the secondary flashlight 104 may all be located within the secondary casing 110, whereas in other embodiments some or all of the components of the power circuit 128 corresponding to the secondary flashlight 104 may be located within the primary casing 108. The possible combinations of components and their physical locations are not limited to the specific embodiments described herein.

Certain embodiments of the subject matter currently disclosed will lend themselves better to certain applications or situations. Some embodiments may be well suited for vehicle lighting, such as on a bicycle, wherein one embodiment the primary flashlight 102 includes a white light emitting lighting element facing forward, and the secondary flashlight 104 could include a red light emitting lighting element facing to the rear. In such a case, both the primary flashlight 102 and the secondary flashlight 104 could include a strobe lighting mode to call attention to the bicycle, or a steady mode to illuminate the area around the bicycle. Other embodiments may lend themselves better to “every-day carry” situations, wherein one carries a flashlight for use in daily life as well as in emergencies. The improvements and features disclosed herein are applicable to a wide variety of situations, and offer better performance as compared to traditional flashlights.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a primary flashlight comprising:
a primary casing;
a primary lighting element; and
a primary power circuit;
a secondary flashlight comprising:
a secondary casing; and
a secondary lighting element; and
a junction member comprising:
a first end coupled to the primary casing; and
a second end coupled to the secondary casing.

2. The apparatus of claim 1, wherein the junction member comprises a pivot that enables the first end and the second end of the junction to move independently.

3. The apparatus of claim 1, wherein:
the primary flashlight comprises a cavity; and
the secondary flashlight and junction member are movable between a first position inside the cavity and a second position outside the cavity.

4. The apparatus of claim 1, wherein the primary power circuit comprises:
a primary power source; and
an alternative primary power source.

5. The apparatus of claim 1, wherein the secondary flashlight comprises a secondary power circuit.

6. The apparatus of claim 5, wherein the secondary power circuit comprises:
a secondary power source; and
an alternative secondary power source.

7. The apparatus of claim 1, wherein the primary power circuit comprises a lighting mode module.

8. The apparatus of claim 5, wherein the secondary power circuit comprises a lighting mode module.

9. An apparatus comprising:
a primary flashlight; and
a secondary flashlight rotatably coupled to the primary flashlight.

10. The apparatus of claim 9, wherein the secondary flashlight is removably coupled to the primary flashlight.

11. The apparatus of claim 9, wherein the primary flashlight comprises an opening configured to store the second flashlight therein.

12. The apparatus of claim 9, wherein the primary flashlight and the secondary flashlight are substantially the same size.

13. The apparatus of claim 9, wherein the primary flashlight and the secondary flashlight are a different size from one another.

14. The apparatus of claim 9, wherein the primary flashlight is larger than the secondary flashlight.

15. The apparatus of claim 9, wherein the primary flashlight and the secondary flashlight are controlled together using a single switch.

16. The apparatus of claim 9, wherein the primary flashlight is controlled using a first switch and the second flashlight is controlled using a second switch.

17. A method comprising:
providing a primary flashlight;
providing a secondary flashlight; and
rotatably coupling the primary flashlight to the secondary flashlight.

18. The method of claim 17, wherein rotatably coupling the primary flashlight to the secondary flashlight comprises attaching a junction member to the primary flashlight and to the secondary flashlight.

19. The method of claim 17, wherein rotatably coupling the primary flashlight to the secondary flashlight comprises attaching a pivot between the primary flashlight and to the secondary flashlight.

20. The method of claim 19, wherein the pivot enables rotation of the secondary flashlight relative to the primary flashlight in a plurality of directions.
